(19) United States
(12) Patent Application Publication
(10) Pub. No.: US 2025/0007295 A1
(43) Pub. Date: Jan. 2, 2025

(54) MEDIUM VOLTAGE DIRECT CURRENT SOLAR PLANT ARCHITECTURE

(71) Applicant: GE Grid Solutions LLC, Atlanta, GA (US)

(72) Inventors: Nathaniel Benedict Hawes, Niskayuna, NY (US); Owen Schelenz, Berlin (DE); Siddharth Pant, Pittsburgh, PA (US)

(21) Appl. No.: 18/755,367

(22) Filed: Jun. 26, 2024

Related U.S. Application Data
(60) Provisional application No. 63/510,520, filed on Jun. 27, 2023.

(51) Int. Cl. H02J 3/46; H02S 10/20

(52) U.S. Cl. CPC H02J 3/46; H02S 10/20

(57) ABSTRACT

A solar power generation system is provided. The solar power generation system includes a plurality of photovoltaic (PV) arrays configured to generate low voltage direct current (LVDC) power, a plurality of DC to DC converters, each of the plurality of DC to DC converters configured to convert the LVDC power to medium voltage DC (MVDC) power, a plurality of branch MVDC busses, a main MVDC bus configured to receive MVDC power from each of the plurality of branch MVDC busses, at least one inverter configured to receive MVDC power from the main MVDC bus and convert the MVDC power to medium voltage alternating current (MVAC) power, and a distribution transformer configured to receive MVAC power from the at least one inverter and convert the MVAC power to high voltage AC power.

### CROSS-REFERENCE TO RELATED APPLICATIONS

This application claims the benefit of priority of U.S. Provisional Application No. 63/510,520, filed Jun. 27, 2023, and entitled “MEDIUM VOLTAGE DIRECT CURRENT SOLAR PLANT ARCHITECTURE,” the contents and disclosures of which are hereby incorporated by reference in their entirety.

### BACKGROUND

The field of the disclosure relates generally to power generation facilities, and more particularly, to an architecture for a solar power generation facility.

The power density of a solar plant is ultimately dictated by the irradiance of solar radiation at the earth's surface. Due to the low value of irradiance, solar plant design becomes a cost optimization problem in how to efficiently collect a low density power from a geographically large area, and concentrate it to a single point, referred to as point of interconnection (POI), where it can enter the electric grid. At least some current utility-scale solar plants collect power emitted from solar panels up to a 1500 volts direct current (DC) level, transmit that power to a local inverter hub where it is stepped up to medium voltage alternating current (AC) power, and then transmit the AC power to the POI for step-up to transmission voltage. As with nearly all electrical systems, the collection and transmission of power is most efficiently performed at high voltage and low current. However, higher safety and insulation costs are typically associated with high voltage levels of high voltage transmission. A solar plant architecture having an increased cost efficiency and an increased energy production efficiency is therefore desirable.

### BRIEF DESCRIPTION

In one aspect, a solar power generation system is provided. The solar power generation system includes a plurality of photovoltaic (PV) arrays configured to generate low voltage direct current (LVDC) power. The solar power generation system further includes a plurality of DC to DC converters, each of the plurality of DC to DC converters configured to receive LVDC power from at least one of the plurality of PV arrays and convert the LVDC power to medium voltage DC (MVDC) power. The solar power generation system further includes a plurality of branch MVDC busses, each of the plurality of branch MVDC busses configured to convey MVDC power from at least one of the plurality of DC to DC converters. The solar power generation system further includes a main MVDC bus configured to receive MVDC power from each of the plurality of branch MVDC busses. The solar power generation system further includes at least one inverter configured to receive MVDC power from the main MVDC bus and convert the MVDC power to medium voltage alternating current (MVAC) power. The solar power generation system further includes a distribution transformer configured to receive MVAC power from the at least one inverter and convert the MVAC power to high voltage AC power.

In another aspect, a method for operating a solar power generation system is provided. The method includes generating, by a plurality of PV arrays, LVDC power. The method further includes converting, by a plurality of DC to DC converters configured to receive LVDC power from at least one of the plurality of PV arrays, the LVDC power to MVDC power. The method further includes conveying, by a plurality of branch MVDC busses, MVDC power from at least one of the plurality of DC to DC converters to a main MVDC bus. The method further includes converting, by at least one inverter configured to receive MVDC power from the main MVDC bus, the MVDC power to MVAC power. The method further includes converting, by a distribution transformer configured to receive MVAC power from the at least one inverter, the MVAC power to high voltage AC power.

In another aspect, a solar power distribution system is provided. The solar power distribution system includes a plurality of DC to DC converters, each of the plurality of DC to DC converters configured to receive LVDC power from at least one of a plurality of PV arrays and convert the LVDC power to MVDC power. The solar power distribution system further includes a plurality of branch MVDC busses, each of the plurality of branch MVDC busses configured to convey MVDC power from at least one of the plurality of DC to DC converters. The solar power distribution system further includes a main MVDC bus configured to receive MVDC power from each of the plurality of branch MVDC busses. The solar power distribution system further includes at least one inverter configured to receive MVDC power from the main MVDC bus and convert the MVDC power to MVAC power. The solar power distribution system further includes a distribution transformer configured to receive MVAC power from the at least one inverter and convert the MVAC power to high voltage AC power.

### BRIEF DESCRIPTION OF DRAWINGS

These and other features, aspects, and advantages of the present disclosure will become better understood when the following detailed description is read with reference to the accompanying drawings in which like characters represent like parts throughout the drawings, wherein:

FIG. 1 is a diagram of an example solar power generation system.

FIG. 2 is a diagram of another example solar power generation system.

FIG. 3 is a diagram of another example solar power generation system.

FIG. 4 is a flowchart of an example method for operating a solar power generation system.

### DETAILED DESCRIPTION

In the following specification and the claims, reference will be made to a number of terms, which shall be defined to have the following meanings.

The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “about,” “substantially,” and “approximately,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

Embodiments of the present disclosure include a solar power generation system. The solar power generation system includes a plurality of photovoltaic (PV) arrays configured to generate low voltage direct current (LVDC) power. The solar power generation system further includes a plurality of DC to DC converters each configured to receive LVDC power from at least one of the plurality of PV arrays and convert the LVDC power to medium voltage DC (MVDC) power. The solar power generation system further includes a plurality of branch MVDC busses, each configured to convey MVDC power from at least one of the plurality of DC to DC converters to a main MVDC bus. The solar power generation system further includes at least one inverter configured to receive MVDC power from the main MVDC and convert the MVDC power to medium voltage alternating current (MVAC) power and a distribution transformer configured to receive MVAC power from the at least one inverter and convert the MVAC power to high voltage AC power for distribution, for example, to a grid and/or load.

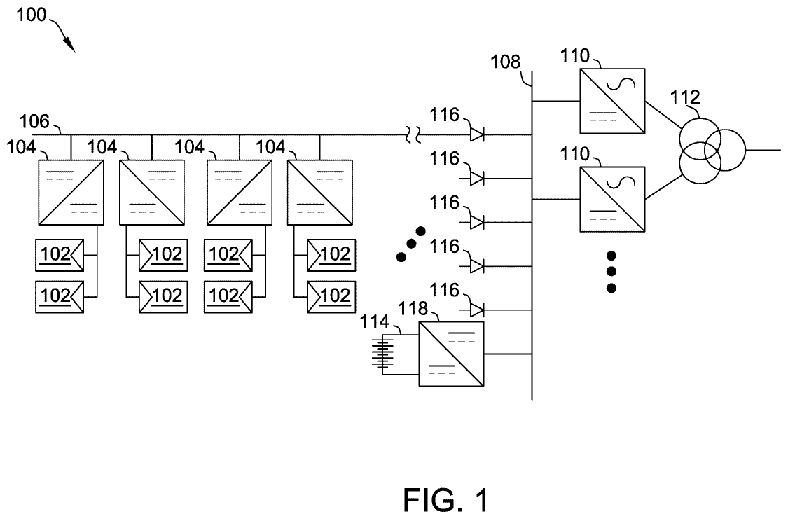

FIG. 1 illustrates an example solar power generation system 100. Solar power generation system 100 includes a plurality of PV arrays 102, a plurality of DC to DC converters 104, a plurality of branch MVDC busses 106, a main MVDC bus 108, one or more inverters 110, a distribution transformer 112, and an energy storage system 114.

PV arrays 102 each include one or more PV panels configured to produce LVDC power from, for example, solar radiation. In some embodiments, PV arrays 102 generate and output DC power at a bipolar voltage level of, for example, about +1.5 kilovolts. Alternatively, in some embodiments, DC power output by PV arrays 102 is unipolar.

DC to DC converters 104 receive the LVDC power produced by PV arrays 102 and are configured to convert the LVDC power output by PV arrays 102 to MVDC power. For example, when LVDC power is received from PV arrays 102, DC to DC converters output DC power at a bipolar voltage level in a range of about +10 kilovolts to about +40 kilovolts, for example. Each DC to DC converter 104 is electrically coupled to at least one PV array 102. Each DC to DC converter 104 has a power capacity sufficient to handle the collective LVDC power received from each PV array 102 coupled thereto. In some embodiments, each DC to DC converter 104 has a power in a range of about 100 kilowatts to about 500 kilowatts.

Branch MVDC busses 106 convey MVDC power output by DC to DC converters 104 to main MVDC bus 108. Each branch MVDC bus 106 is electrically coupled to and receives MVDC power from one or more DC to DC converters 104. Each MVDC bus is electrically coupled to main MVDC bus 108 via a diode 116, which enables current to flow from branch MVDC busses 106 to main MVDC bus 108 but prevents a reverse flow of current from main MVDC bus 108 to DC to DC converters 104.

Main MVDC bus 108 receives MVDC power from each DC to DC converter 104 via branch MVDC busses 106. Main MVDC bus 108 is electrically coupled to one or more inverters 110, which receive MVDC power from main MVDC bus 108 and convert the MVDC power to MVAC power. Each inverter 110 is in turn electrically coupled to distribution transformer 112, which converts the MVAC power output by inverters 110 to AC power of a voltage level (e.g., high voltage) suitable for transmission to an electrical grid and/or load. Because AC power transmission generally results in at least some reactive power losses, by utilizing DC power transmission within solar power generation system 100, such reactive power losses may be reduced compared to systems that, for example, use AC power transmission to convey power from local inverter hubs to the POI. Additionally, a current requirement is reduced by utilizing DC power transmission, which further reduces power losses. Further, DC to DC converters 104 are in some cheaper to produce and install than the local inverter hubs of systems utilizing MVAC power transmission.

Energy storage system 114 is configured to store electrical energy generated by PV arrays 102. For example, energy storage system 114 may store electrical energy when PV arrays 102 are generating power (e.g., during the day or sunny conditions) and output power when PV arrays 102 are not generating power (e.g., during the night or cloudy conditions), in order to maintain a consistent power output of solar power generation system 100. Energy storage system may be, for example, a battery energy storage system (BESS) including one or more battery elements and/or other components for storing electrical energy received via, for example, main MVDC bus 108 and supplying stored energy back through main MVDC bus 108. In some embodiments, energy storage system 114 includes a DC to DC converter 118, and is electrically coupled to main MVDC bus 108 via DC to DC converter 118. DC to DC converter 118 is configured to convert MVDC power supplied from main MVDC bus 108 to a power suitable for supplying to energy storage system 114, and to convert power supplied by energy storage system 114 to MVDC power. Additionally, DC to DC converter 118 may reduce fault currents present in main MVDC bus 108 and may provide an additional layer of control available for operators of solar power generation system 200. While energy storage system 114 is shown in FIG. 1 as coupled to main MVDC bus 108, in alternative embodiments, energy storage system 114 may be coupled to another component of solar power generation system 100, such as one of branch MVDC busses 106.

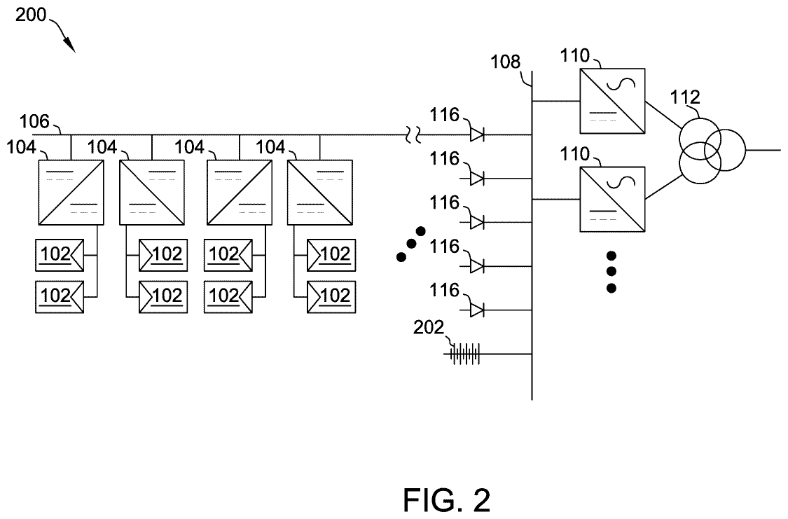

FIG. 2 illustrates another example solar power generation system 200. Solar power generation system 200 includes PV arrays 102, DC to DC converters 104, branch MVDC busses 106, main MVDC bus 108, inverters 110, distribution transformer 112, and energy storage system 114, which generally function described with respect to solar power generation system 100 (shown in FIG. 1). As shown in FIG. 2, in some embodiments, energy storage system 114 is coupled directly to main MVDC bus 108 without an intermediate converter such as DC to DC converter 118, which may result in decreased component costs, gains in energy efficiency, and improvement in system stability during transient conditions.

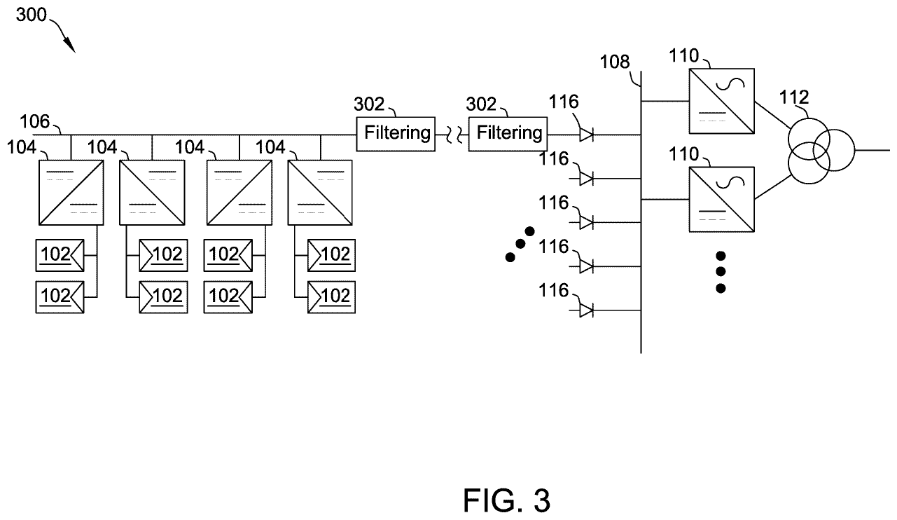

FIG. 3 illustrates another example solar power generation system 300. Solar power generation system 300 includes PV arrays 102, DC to DC converters 104, branch MVDC busses 106, main MVDC bus 108, inverters 110, distribution transformer 112, and energy storage system 114, which generally function as described with respect to solar power generation system 100 (shown in FIG. 1). Solar power generation system 300 further includes at least one filter 302 electrically coupled between branch MVDC bus 106 and main MVDC bus 108. Filters 302 are configured to filter high frequency components from branch MVDC busses 106, such as those that may result from high frequency switching. Accordingly, filters 302 reduce undesirable voltage reflections within branch MVDC busses 106.

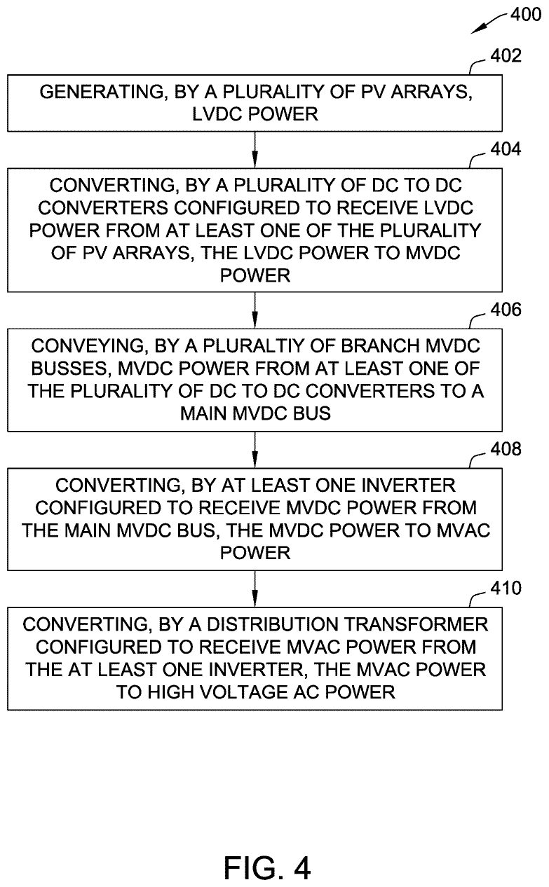

FIG. 4 is a flowchart illustrating an example method 400 for operating a solar power generation system, such as solar power generation system 100 (shown in FIG. 1). Method 400 includes generating 402, by a plurality of PV arrays (such as PV arrays 102), LVDC power. Method 400 further includes converting 404, by a plurality of DC to DC converters (such as DC to DC converters 104) configured to receive LVDC power from at least one of the plurality of PV arrays, the LVDC power to MVDC power. Method 400 further includes conveying 406, by a plurality of branch MVDC busses (such as branch MVDC busses 106), MVDC power from at least one of the plurality of DC to DC converters to a main MVDC bus (such as main MVDC bus 108). Method 400 further includes converting 408, by at least one inverter (such as inverter 110) configured to receive MVDC power from the main MVDC bus, the MVDC power to MVAC power. Method 400 further includes converting 410, by a distribution transformer (such as distribution transformer 112) configured to receive MVAC power from the at least one inverter, the MVAC power to high voltage AC power.

In some embodiments, each of a plurality of diodes (such as diodes 116) is electrically coupled between one of the plurality of branch MVDC busses and the main MVDC bus.

In some embodiments, method 400 further includes storing energy generated by at least some of the plurality of PV arrays in an energy storage system (such as energy storage system 114). In some such embodiments, the energy storage system is electrically coupled to the main MVDC bus.

In some embodiments, a plurality of filters are electrically coupled between one of the plurality of branch MVDC busses and the main MVDC bus.

In some embodiments, the LVDC power has a bipolar voltage of about ±1.5 kilovolts.

In some embodiments, the MVDC power has a bipolar voltage in a range of about ±10 kilovolts to about ±40 kilovolts.

An example technical effect of the methods, systems, and apparatus described herein includes at least one of: (a) improving safety and reducing insulation costs of a solar power distribution system by using an intermediate MVDC bus to convey power within the solar power distribution system; (b) reducing impedance-related electrical losses in a solar power distribution system by using an intermediate MVDC bus convey power within the solar power distribution system; and/or (c) reducing a number of inverters needed in a solar power distribution system by using one or more DC to DC converters within the solar power distribution system.

Example embodiments of a solar power generation system are provided herein. The systems and methods of operating and manufacturing such systems and devices are not limited to the specific embodiments described herein, but rather, components of systems and/or steps of the methods may be utilized independently and separately from other components and/or steps described herein. For example, the methods may also be used in combination with other electronic systems, and are not limited to practice with only the electronic systems, and methods as described herein. Rather, the example embodiments can be implemented and utilized in connection with many other electronic systems.

Some embodiments involve the use of one or more electronic or computing devices. Such devices typically include a processor, processing device, or controller, such as a general purpose central processing unit (CPU), a graphics processing unit (GPU), a microcontroller, a reduced instruction set computer (RISC) processor, an application specific integrated circuit (ASIC), a programmable logic circuit (PLC), a field programmable gate array (FPGA), a digital signal processing (DSP) device, and/or any other circuit or processing device capable of executing the functions described herein. The methods described herein may be encoded as executable instructions embodied in a computer readable medium, including, without limitation, a storage device and/or a memory device. Such instructions, when executed by a processing device, cause the processing device to perform at least a portion of the methods described herein. The above embodiments are examples only, and thus are not intended to limit in any way the definition and/or meaning of the term processor and processing device.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A solar power generation system comprising:
a plurality of photovoltaic (PV) arrays configured to generate low voltage direct current (LVDC) power;
a plurality of DC to DC converters, each of said plurality of DC to DC converters configured to receive LVDC power from at least one of said plurality of PV arrays and convert the LVDC power to medium voltage DC (MVDC) power;
a plurality of branch MVDC busses, each of said plurality of branch MVDC busses configured to convey MVDC power from at least one of the plurality of DC to DC converters;
a main MVDC bus configured to receive MVDC power from each of said plurality of branch MVDC busses;
at least one inverter configured to receive MVDC power from said main MVDC bus and convert the MVDC power to medium voltage alternating current (MVAC) power; and
a distribution transformer configured to receive MVAC power from said at least one inverter and convert the MVAC power to high voltage AC power.

2. The solar power generation system of claim 1, further comprising a plurality of diodes, each of said plurality of diodes electrically coupled between one of said plurality of branch MVDC busses and said main MVDC bus.

3. The solar power generation system of claim 1, further comprising an energy storage system configured to store energy generated by at least some of said plurality of PV arrays.

4. The solar power generation system of claim 3, wherein said energy storage system is electrically coupled to said main MVDC bus.

5. The solar power generation system of claim 1, further comprising a plurality of filters, each of said plurality of filters electrically coupled between one of said plurality of branch MVDC busses and said main MVDC bus.

6. The solar power generation system of claim 1, wherein the LVDC power has a bipolar voltage of about ±1.5 kilovolts.

7. The solar power generation system of claim 1, wherein the MVDC power has a bipolar voltage in a range of about ±10 kilovolts to about ±40 kilovolts.

8. A method for operating a solar power generation system, said method comprising:
generating, by a plurality of photovoltaic (PV) arrays, low voltage direct current (LVDC) power;
converting, by a plurality of DC to DC converters configured to receive LVDC power from at least one of the plurality of PV arrays, the LVDC power to medium voltage DC (MVDC) power;
conveying, by a plurality of branch MVDC busses, MVDC power from at least one of the plurality of DC to DC converters to a main MVDC bus;
converting, by at least one inverter configured to receive MVDC power from the main MVDC bus, the MVDC power to medium voltage alternating current (MVAC) power; and
converting, by a distribution transformer configured to receive MVAC power from the at least one inverter, the MVAC power to high voltage AC power.

9. The method of claim 8, wherein each of a plurality of diodes is electrically coupled between one of the plurality of branch MVDC busses and the main MVDC bus.

10. The method of claim 8, further comprising storing energy generated by at least some of the plurality of PV arrays in an energy storage system.

11. The method of claim 10, wherein the energy storage system is electrically coupled to the main MVDC bus.

12. The method of claim 8, wherein a plurality of filters are electrically coupled between one of the plurality of branch MVDC busses and the main MVDC bus.

13. The method of claim 8, wherein the LVDC power has a bipolar voltage of about ±1.5 kilovolts.

14. The method of claim 8, wherein the MVDC power has a bipolar voltage in a range of about ±10 kilovolts to about ±40 kilovolts.

15. A solar power distribution system comprising:
a plurality of direct current (DC) to DC converters, each of said plurality of DC to DC converters configured to receive low voltage DC (LVDC) power from at least one of a plurality of photovoltaic (PV) arrays and convert the LVDC power to medium voltage DC (MVDC) power;
a plurality of branch MVDC busses, each of said plurality of branch MVDC busses configured to convey MVDC power from at least one of the plurality of DC to DC converters;
a main MVDC bus configured to receive MVDC power from each of said plurality of branch MVDC busses;
at least one inverter configured to receive MVDC power from said main MVDC bus and convert the MVDC power to medium voltage alternating current (MVAC) power; and
a distribution transformer configured to receive MVAC power from said at least one inverter and convert the MVAC power to high voltage AC power.

16. The solar power distribution system of claim 15, further comprising a plurality of diodes, each of said plurality of diodes electrically coupled between one of said plurality of branch MVDC busses and said main MVDC bus.

17. The solar power distribution system of claim 15, further comprising an energy storage system configured to store energy generated by at least some of said plurality of PV arrays.

18. The solar power distribution system of claim 17, wherein said energy storage system is electrically coupled to said main MVDC bus.

19. The solar power distribution system of claim 15, further comprising a plurality of filters, each of said plurality of filters electrically coupled between one of said plurality of branch MVDC busses and said main MVDC bus.

20. The solar power distribution system of claim 15, wherein the LVDC power has a bipolar voltage of about ±1.5 kilovolts.
